(19) United States
(12) Patent Application Publication
(10) Pub. No.: US 2012/0100361 A1
(43) Pub. Date: Apr. 26, 2012

(54) ANTISEPTIC COMPOSITION FOR ENGINEERING WOOD PRODUCTION, AND ENGINEERING WOOD

(75) Inventors: Keijitsu Tanaka, Tsukuba-shi (JP); Motoki Tanaka, Tsukuba-shi (JP)

(73) Assignee: SDS BIOTECH K.K., Chuo-ku (JP)

(21) Appl. No.: 13/380,781

(22) PCT Filed: Apr. 15, 2010
(86) PCT No.: PCT/JP2010/056737

§ 371 Date: Dec. 23, 2011

(30) Foreign Application Priority Data
Jul. 23, 2009 (JP) PCT/JP2009/063146

(51) Int. Cl. B32B 27/04; A01P 1/00; B32B 27/38; A01N 43/653

(52) U.S. Cl. 428/297.4; 514/383; 428/413

(57) ABSTRACT

The present invention provides an antiseptic composition for engineering wood production, which contains epoxyconazole and a thermosetting resin, and engineering wood which is obtained using the antiseptic composition. The antiseptic composition of the present invention enables efficient production of engineering wood such as plywood or laminated veneer lumber (LVL) that has a high antiseptic effect.

### TECHNICAL FIELD

The present invention relates to a wood preservative composition. Specifically, the present invention relates to an antiseptic composition for engineering wood production prepared by mixing a specific antiseptic into glue used in the production of so-called engineering wood such as laminated veneer lumber (LVL) and plywood, and to the engineering wood produced by using the antiseptic composition.

### BACKGROUND ART

So-called engineering wood such as plywood and laminated veneer lumber (LVL) is an excellent material which overcomes the drawback of the solid wood and its future growth in production is expected. However, since the low-grade wood such as south-sea wood is used as the raw material of the engineering wood, the engineering wood is disadvantageous in that it is vulnerable to biological deterioration (decay and insect damage).

The preservative and insecticidal treatment of the engineering wood is broadly classified into the drug pressure treatment and the glue line treatment containing antiseptic agent. While a large-scale plant for pressure injection is required separately in the drug pressure treatment, the glue line treatment can produce the preservative-treated engineering wood only by mixing an antiseptic into glue. Therefore, it can be said that the glue line treatment is a more efficient treatment method.

In the glue line treatment, it is necessary to select the chemicals (preservative) considering the treatment conditions, which are different from those in the drug pressure treatment and in the surface treatment. That is, since the glue used in the production of engineering wood is generally based on a resin such as phenol resin which is heat curable in the alkaline region, the following properties are required for the preservative to be mixed into the glue: (1) to have compatibility with the base resin; (2) not to be degraded in the alkali region at a pH range from 9 to 13 (i.e.: to have alkaline resistance); and (3) not to be degraded under the thermosetting conditions (at 130 to 150° C.) (i.e.: to have heat resistance), in addition to the preservative basal activity.

However, there has been no prior art which specifically discloses an antiseptic satisfying the above-mentioned conditions (1) to (3). There is no art which specifically discloses actual production of engineering wood having excellent antiseptic property using glue containing such an antiseptic, either.

The epoxyconazole used in the antiseptic composition for producing engineering wood of the present invention (hereinafter may be abbreviated as a wood preservative composition) is a known compound and there have been a number of references disclosing the compound from old times.

For example, JP-B-H04-74355 (U.S. Pat. No. 4,464,381) (Patent Document 1) teaches that epoxyconazole can be used for the control of wood decay fungi. Japanese Patent No. 3541975 (Australian Patent No. 698343) (Patent Document 2), JP-A-2000-95621 (WO 00/004776) (Patent Document 3), JP-A-2003-73211 (Patent Document 4), JP-A-2003-81714 (Patent Document 5), JP-A-2003-252705 (Patent Document 6), JP-A-2005-47056 (Patent Document 7), JP-A-2007-118261 (Patent Document 8), JP-A-2007-254321 (Patent Document 9) and JP-A-2009-96751 (Patent Document 10) respectively discloses a composition containing epoxyconazole as one of the numerous examples of antiseptics and preservatives and teaches the composition can be used in the glue line treatment. However, these documents make no mention of an example where epoxyconazole is actually used in the glue line treatment. WO 98/018328 bulletin (Patent Document 11) discloses a binder for producing wood materials, which binder contains a specific insecticidal composition and an azole compound as a fungicide, but the document does not describe epoxyconazole.

These prior art documents do not describe an example of producing engineering wood having antiseptic property by actually performing the glue line treatment using epoxyconazole, let alone the fact that epoxyconazole shows a particularly high antiseptic effect in the glue line treatment.

### PRIOR ART

### Patent Documents

Patent Document 1: JP-B-H04-74355 (U.S. Pat. No. 4,464,381)
Patent Document 2: Japanese Patent No. 3541975 (Australian Patent No. 698343)
Patent Document 3: JP-A-2000-95621 (WO 00/004776)
Patent Document 4: JP-A-2003-73211
Patent Document 5: JP-A-2003-81714
Patent Document 6: JP-A-2003-252705
Patent Document 7: JP-A-2005-47056
Patent Document 8: JP-A-2007-118261
Patent Document 9: JP-A-2007-254321
Patent Document 10: JP-A-2009-96751
Patent Document 11: WO 98/018328 bulletin

### DISCLOSURE OF THE INVENTION

### Problems to be Solved by the Invention

Accordingly, an object of the present invention is to provide an antiseptic composition for use in producing enginnering wood such as plywood and laminated veneer lumber (LVL), which enables efficient production of engineering wood having a high antiseptic effect; and to provide the engineering wood obtained by using the antiseptic composition.

### Means to Solve the Problem

The present inventors conducted quite extensive experiments using glue in practical use for producing engineering wood and numerous chemicals having antiseptic activity. As a result, the present inventors have found that among these numerous chemicals only epoxyconazole is suitable for the conditions for producing engineering wood such as plywood and laminated veneer lumber (LVL) and exhibits an antiseptic effect at a very low concentration, and have accomplished the invention.

That is, the present invention provides the antiseptic composition for producing engineering wood and the engineering wood as follows:
1. An antiseptic composition for producing engineering wood which contains epoxyconazole and thermosetting resin.
2. The antiseptic composition for producing engineering wood as described in 1 above, wherein the thermosetting resin is selected from a group consisting of phenol resin, phenol resorcinol copolymer resin, urea resin, urea melamine resin and melamine phenol resin.
3. The antiseptic composition for producing engineering wood as described in 1 or 2 above, wherein the engineering wood is plywood, laminated veneer lumber (LVL), a particle board or a fiber board.
4. Engineering wood produced by using the antiseptic composition as described in any one of 1 to 3 above.
5. The engineering wood as described in 4 above, which is plywood, laminated veneer lumber (LVL), a particle board or a fiber board.

### EFFECTS OF THE INVENTION

The present invention is to provide a wood preservative composition in which a specific antiseptic (epoxyconazole) which would remain unaltered under the production conditions is mixed in glue used for producing engineering wood. The wood preservative composition of the present invention enables efficient production of engineering wood having an excellent antiseptic effect in a small amount of active ingredients.

### MODE FOR CARRYING OUT THE INVENTION

In the present invention, epoxyconazole is used as an active ingredient of the antiseptic composition for producing engineering wood.

Epoxyconazole used as an active ingredient in the present invention can be produced by a known method such as the method described in JP-B-H04-74355 (U.S. Pat. No. 4,464,381).

When the antiseptic composition for producing engineering wood of the present invention is prepared, active ingredients as they are may be added to be used. However, generally, the active ingredients are previously mixed with solid carriers, liquid carriers or gas carriers with addition of a surfactant and other adjuvants for drug formulations as needed to thereby be formulated into the forms such as an oil solution, an emulsion, a solubilizer, a wettable powder, a suspension, a flowable formulation and a dust formulation.

Examples of the solvent which can be used for preparing these formulations include aromatic organic solvents such as toluene-based, xylene-based or methylnaphthalene-based solvents; halogenated hydrocarbon such as dichloromethane and trichloroethane; alcohols such as isopropyl alcohol and benzyl alcohol; glycol-based solvents such as polyethylene glycol and polypropylene glycol; kerosene; N-methyl pyrolidone; ester phosphate; and benzoic acid ester.

As the surfactant to be used for formulations, an anionic, nonionic or zwitterionic surfactant can be used.

The wood preservative composition of the present invention generally contains active ingredients in an amount of 0.01 to 90 mass %, and preferably in an amount of 0.1 to 50 mass %.

Using the active ingredients of the wood preservative composition of the present invention in combination with other antibiotic compounds enables further enhancing the antibiotic effect and expanding the action spectrum of the drug. The wood treatment using other antibiotic compounds may be carried out as pretreatment (treatment of the veneer before bonding) or posttreatment (treatment of the produced engineering wood) of the treatment by the wood preservative composition (glue) treatment according to the present invention. However, the treatment using the antibiotic compounds and the treatment by the wood preservative composition can be carried out at the same time using the antibiotic compounds added to the wood preservative of the present invention.

Preferable examples of the antibiotic compound which can be used for the above-mentioned purpose include copper compounds. Examples of the copper compound include copper sulfate, copper chloride, copper phosphate, copper hydroxide, copper carbonate, basic copper carbonate, basic copper acetate, basic copper phosphate, basic coopper chloride, copper oxide, copper(I) oxide, copper acetate, copper naphthenate, copper oleate, copper stearate, copper octanoate, copper benzoate, copper citrate, copper lactate, copper tartrate, copper 2-ethylhexanoate, complexes of these compounds stabilized as a water-soluble component; and hydrates of these compounds. In the case where these formulations are designed to be water-reducible, conventionally known ammonium compounds and amine compounds can be used to keep copper compound as a stable solution. Specific example of the compounds include ammonia, ammonium carbonate, ammonium bicarbonate, ethanolamine, diethanolamine, triethanolamine, propanolamine, triisopropanolamine, N-methylethanolamine, N-methyl diethanolamine, N,N-dimethylethanolamine, N-ethylethanolamine, N-ethyldiethanolamine, isopropanol amine, aminoethylethanolamine, ethylenediamine, diethylenetriamine, triethylenetetramine, tetraethylenepentamine, pentaethylenehexamine, polyethyleneimine, N,N-dimethylethylenediamine, 1,2-propanediamine, 1,3-propanediamine and polyallylamine. Also, various carbonate compounds, carboxylic compounds or mineral acids may be further added to control the pH. Specifically, boric acid, naphthenic acid, formic acid, acetic acid, propionic acid, hexanoic acid, heptanoic acid, octanoic acid, stearic acid, palmitic acid, oleic acid, benzoic acid, citric acid, lactic acid, tartaric acid, malic acid, succinic acid, adipic acid, fumaric acid, malonic acid, gulconic acid, sebacic acid, cyclohexanoic acid, 2-ethylhexanoic acid, isooctanoic acid, sodium bicarbonate, ammonium bicarbonate, phosphoric acid, sodium dihydrogen phosphate, potassium dihydrogen phosphate and hydrates thereof may be used.

In the wood preservative of the present invention, preferred examples of the other antibiotic compounds to be used in combination for the purpose of enhancing the antibiotic effect and expanding the action spectrum include triazoles such as azaconazole, bitertanol, bromuconazole, cyproconazole, diniconazole, fenbuconazole, fluquinconazole, flusilazole, flutriafol, hexaconazole, imibenconazole, ipconazole, metconazole, myclobutanil, paclobutrazol, penconazole, propiconazole, tebuconazole, tetraconazole, triadimefon, triadimenol, triticonazole, uniconazole, hexaconazole and 2-(2,4-difluorophenyl)-1-(1H-1,2,4-triazole-1-yl)-3-(trimethylsilyl)propan-2-ol; strobins such as azoxystrobin, picoxystrobin and pyraclostrobin; sulfonamides such as dichlorofluanid (Euparene), tolyfluanid (Methyleuparene), cyclofluanid, folpet and fluorofolpet; benzimidazoles such as carbendazim (MBC), benomyl, fuberidazole, thiabendazole and salts thereof; thiocyanates such as thiocyanatemethylthio benzothiazole (TCMTB), and methylene bis thiocyanate (MBT); morpholine derivatives such as C₁₁-C₁₄-4-alkyl-2,6-dimethylmorpholine homologues (Tridemorph) and (±)-cis-4-[3-(t-butylphenyl)-2-methylpropyl]-2,6-dimethylmorpholine (Fenpropimorph, Falimorph); phenols such as o-phenylphenol, tribromophenol, tetrachlorophenol, pentachlorophenol, 3-methyl-4-chlorophenol, dichlorophenol, chlorophen and salts thereof; organic iodine compounds such as 3-iodo-2-propynyl-n-butyl carbamate (IPBC), 3-iodo-2-propynyl-n-hexyl carbamate, 3-iodo-2-propynyl cyclohexyl carbamate, 3-iodo-2-propynyl phenyl carbamate, 3-iodo-2-propynil-n-butyl carbamate, p-chlorophenyl-3-iodo propargylformal (IF-1000), 3-bromo-2,3-diiodo-2-propenylethyl carbonate (Sunplus) and 1-[(diiodomethyl)sulfonyl]-4-methylbenzene (Amical); organic bromo derivatives such as Bronopol; isothiazolines such as N-methylisothiazoline-3-on, 5-chloro-N-methylisothiazoline-3-on, 4,5-dichloro-N-octylisothiazoline-3-on and N-octylisothiazoline-3-on (Octylinone); benzisothiazolines such as cyclopentaisothiazoline; pyridines such as 1-hydroxy-2-pyridinethione (or sodium salts, iron salts, manganese salts, zinc salts and the like thereof) and tetrachloro-4-methylsulfonylpyridine; metal soaps such as naphthate, octoate, 2-ethylhexanoate, oleate, phosphate, benzoate and the like of tin, copper and zinc; oxides such as Cu₂O, CuO and ZnO; organic tin derivatives such as tributyltin naphthenate and t-butyltin oxide; metal compounds such as tris-N-(cyclohexyldiazenium dioxine)-tributyl tin or potassium salts, and bis-(N-cyclohexyl)diazonium-dioxine copper or aluminum; carbamates such as sodium or zinc salts of dialkyl dithiocarbamate and tetramethylthiuram disulfide (TMTD); nitriles such as 2,4,5,6-tetrachloroisophthalonitrile (Chlorothalonil); antimicrobial agents having an activated halogen atom such as Cl—Ac, MCA, tectamer, bronopol and brumidox; benzothiazoles such as 2-mercaptobenzothiazole and dazomet; quinolines such as 8-hydroxyquinoline; compounds generating formaldehyde such as benzylalcoholmono(poly)hemiformal, oxazolidine, hexahydro-s-triazine and N-methylol-chloroacetamide; boron compounds such as disodium octaborate tetrahydrate, boric acid and borax; fluorine compounds such as sodium fluoride and sodium fluorosilicate; ester phosphates such as azinphos-ethyl, azinphos-methyl, 1-(4-chlorophenyl)-4-(O-ethyl, S-propyl)phosphoryloxypyrazole (TIA-230), chlorpyriphos, tetrachlorvinphos, coumaphos, dethomen-S-methyl, diazinon, dichlorvos, dimethoate, ethoprophos, etholimphos, fenitrothion, pyridafenthion, heptenophos, parathion, parathion-methyl, propetanphos, phosalone, phoxim, pyrimphos-ethyl, pyrimiphos-methyl, profenophos, prothiophos, sulprophos, triazophos and trichlorfon; carbamates such as aldicarb, beniocarb, BPMC (2-(1-methylpropyl)phenylmethyl carbamate, butocarboxym, butoxycarboxym, carbaryl, carbofuran, carbosulfan, chloethocarb, isoprocarb, methomyl, oxamyl, pirimicarb, promecarb, propoxur and thiodicarb; pyrethroids such as allethrin, alphamethrin, empenthrin, profluthrin, tralomethrin, methofluthrin, phenothrin, imiprothrin, cyphenothrin, futarthrin, pyrethrin, prallethrin, furamethrin, dimefluthrin, profluthrin, tefluthrin, bioallethrin, esbiothrin, bioresmethrin, cycloprothrin, cyfluthrin, decamethrin, cyhalothrin, cypermethrin, deltamethrin, permethrin, resmethrin, fenpropathrin, fenfluthrin, fenvalerate, flucythrinate, flumthrin, fluvalinate and ethophenprox; neonicotinoids such as acetamiprid, imidacloprid, thiacloprid, chlothianidin, dinotefuran, thiamethoxam and nitenpyram. These antibiotic compounds may be used solely or in combination of the two or more thereof.

Wood Decay Fungi:

The wood preservative of the present invention is effective on the wood decay fungi including the following kinds of fungi: basidiomycetes including Coniophora puteana, Trametes versicolor, Postia placenta, Poria vaporaria, Poria vaillantii, Gloeophylium sepiarium, Gloeophylium adoratum, Gloeophylium abietinum, Gloeophylium trabeum, Gloeophylium protactumm, Lentinus lepideus, Lentinus edodes, Lentinus cyathiformes, Lentinus squarrolosus, Paxillus panuoides, Fomitopsis palustris, Pleurotus ostreatus, Donkioporia expansa, Serpula lacrymans, Serpula himantoides, Glenospora graphii, Fomitopsis lilacino-gilva, Perenniporia tephropora, Antrodia xantha and Antrodia vaillantii; Deuteromycetes including Cladosporium herbarum; and Ascomycetes including Chaetomiumu globsum, Chaetomium alba-arenulum, Petriella setifera, Trichurus spiralis and Humicola grisera.

The wood preservative of the present invention is effective on the sap-staining fungi including the following kinds of fungi: Deuteromycetes including Aureobasidium pullulans, Scleroph pithyophila, Scopular phycomyces, Aspergillus niger, Penicillium variabile, Trichoderma viride, Trichoderma rignorum and Dactyleum fusarioides; Ascomycetes including Caratocystis minor; and Zygomycetes including Mucor spinosus.

Treatment Object:

The wood preservative of the present invention can be used for the production of various engineering wood such as plywood, laminated veneer lumber (LVL), particle boards and fiber boards, and can produce a great antiseptic effect on these engineering wood.

The plywood means the one which is composed of thin boards cut out from the lumber: i.e. veneers, by bonding odd number of the veneer sheets such that the fiber directions of the adjacent veneer sheets cross each other at right angles.

The LVL is a product obtained by bonding a few or tens of laminated veneer sheets having a thickness of about 2 to 4 mm cut by a rotary lathe or a slicer, generally setting the fiber directions of the veneer sheets almost parallel to each other, and may be referred to as the “laminated veneer lumber (LVL)” or parallel-laminated veneer.

A particle board is a wood board obtained by mixing wood chips with glue followed by heat pressure molding.

A fiber board is a wood board obtained by mixing the pulped wood fiber with glue followed by heat pressure molding, and classified into the insulation board (density: less than 0.35 g/cm³), mid density fiber board (MDF) (density: 0.35 g/cm³ to 0.80 g/cm³) and hard board (density: 0.85 g/cm³ or more) in ascending order of density.

As a base resin of the glue used for the wood preservative composition of the present invention, phenol resin (alkaline resol resin), phenol resorcinol copolymer resin, urea resin, urea melamine resin and melamine phenol resin can be used. Phenol resin (alkaline resol resin), phenol resorcinol copolymer resin and melamine phenol resin as being an alkaline base resin can be used suitably, and phenol resin (alkaline resol resin) can be used more suitably.

Generally, in these glues, wheat flour, wood powder, walnut shell flour and coconut shell flour are used in an effort to prevent excessive permeation into the wood material, to promote hardening, to control viscosity and to prevent the aging of the glue line; and inorganic salts are used as a hardening agent.

In the present invention, it is preferable to add active ingredients (an antiseptic) to the glue when blending the above-mentioned additives into the glue.

The concentration of the active ingredients in the engineering wood (plywood, LVL and the like) produced using the wood preservative composition of the present invention is generally 0.1 to 500 g/m³ (the absorbed amount per wood material), and preferably 1 to 150 g/m³.

The wood preservative composition of the present invention as being glue blended with active ingredients is applied on the veneer surface by a glue spreader, a roll spreader or an extruder coater. A standard quantity for application is 50 to 500 g/m². After laminating the veneer on which the composition is applied, the glue is hardened by cold pressing and heating to be made into a final product. The hot pressing temperature, which may vary to some extent depending on the glue, is generally 50 to 200 ° C. and preferably 100 to 150°. The hot pressing time, which also may vary to some extent depending on the glue, is generally 5 to 300 second/mm and preferably 10 to 60 second/mm. The compression pressure, which varies depending on the species of wood and the specific gravity of the veneer sheet to be used, is generally 5 to 20 kgf/cm² and preferably 7 to 15 kgf/cm².

### EXAMPLES

The invention will be described with reference to Examples and Comparative Examples below, but the invention is not limited to these examples.

### Preparation Example 1

The following compounds, which are known to have wood preservative activity, are dissolved in methyl ethylene triglycol to reach a concentration of 10% (w/w) to thereby obtain a solution of each of the compounds.

Epoxyconazole (manufactured by Wako Pure Chemical Industries, Ltd.; the same shall apply hereinafter.) (Example 1), hexaconazole (Comparative Example 1), 2-(2,4-difluorophenyl)-1-(1H-1,2,4-triazole-1-yl)-3-(trimethylsilyl)propane-2-ol (prepared according to the method described in JP-B-H07-68251) (Comparative Example 2), benzalkonium chloride (Comparative Example 3), didecyldimethylammonium chloride (Comparative Example 4), cyproconazole (Comparative Example 5), tebuconazole (Comparative Example 6), azaconazole (Comparative Example 7), simeconazole (Comparative Example 8), fenbuconazole (Comparative Example 9), flusilazole (Comparative Example 10), flutriafol (Comparative Example 11), imibenconazole (Comparative Example 12), ipconazole (Comparative Example 13), metconazole (Comparative Example 14), myclobutanil (Comparative Example 15), penconazole (Comparative Example 16), propiconazole (Comparative Example 17), tetraconazole (Comparative Example 18), triadimefon (Comparative Example 19), triticonazole (Comparative Example 20), azoxystrobin (Comparative Example 21), pyraclostrobin (Comparative Example 22), 3-iode-2-propynyl-n-butylcarbamate (IPBC) (manufactured by Nagase ChemteX Corporation) (Comparative Example 23), N-octylisothiazolin-3-one (manufactured by Nagase ChemteX Corporation) (Comparative Example 24) and chlorothalonil (manufactured by SDS BIOTECH K.K.) (Comparative Example 25)

### Test Example 1

### Test for Miscibility with a Phenol Resin Glue

1000 g of phenol resin-based glue Deernol D-117 (manufactured by Oshika Corporation), 70 g of wheat flour and 100 g of calcium carbonate were mixed and well kneaded. Each of the solutions of Example 1 and Comparative Example 1 to 25 was added to 17 g of the kneaded product and mixed well together. The viscosity change of the glue was visually observed for 60 minutes. The results are shown in Table 1. It was proved from Table 1 that the compounds of Comparative Examples 3 and 4 harden the glue and have a problem from a practical viewpoint. Although a number of documents listed as the prior art documents and the like teach that quaternary ammonium compounds can be applied to the glue line treatment, it is clear that those compounds have a problem for practical use (Comparative Examples 3 and 4). On the other hand, it was confirmed that the other compounds including that of Example has no problem from the viewpoint of compatibility.

TABLE 1
Test for miscibility with phenol resin

| | Phenol resin status |
|---|---|
| Antiseptic composition | after 60 minutes |
| Example 1 | ∘ |
| Comparative Example 1 | ∘ |
| Comparative Example 2 | ∘ |
| Comparative Example 3 | x |
| Comparative Example 4 | x |
| Comparative Example 5 | ∘ |
| Comparative Example 6 | ∘ |
| Comparative Example 7 | ∘ |
| Comparative Example 8 | ∘ |
| Comparative Example 9 | ∘ |
| Comparative Example 10 | ∘ |
| Comparative Example 11 | ∘ |
| Comparative Example 12 | ∘ |
| Comparative Example 13 | ∘ |
| Comparative Example 14 | ∘ |
| Comparative Example 15 | ∘ |
| Comparative Example 16 | ∘ |
| Comparative Example 17 | ∘ |
| Comparative Example 18 | ∘ |
| Comparative Example 19 | ∘ |
| Comparative Example 20 | ∘ |
| Comparative Example 21 | ∘ |
| Comparative Example 22 | ∘ |
| Comparative Example 23 | ∘ |
| Comparative Example 24 | ∘ |
| Comparative Example 25 | ∘ |

∘: No change
x: Obvious increase in the viscosity was seen and it seems impossible to apply the composition onto the veneer sheet

### Preparation Example 2

### Preparation of the Preservative Plywood by Urea Melamine Resin

1000 g of urea melamine resin (PWP-60, manufactured by Oshika Corporation) was added to 180 g of wheat flour and fully kneaded to thereby obtain a kneaded product. 8 g of ammonium chloride was added as a hardening agent to the kneaded product, and a solution of each of the compounds of Example 1 and Comparative Example 1, 2 and 5 to 25 was further added thereto so that the final concentrations of the compound in the wood become 150, 100, 50 and 25 g/m³ and kneaded. 18 g of the above kneaded product was applied onto each of the bonding plane of the three red lauan veneer sheets having an area of 30 x 30 cm and thickness of 0.85 mm/2.4 mm/0.85 mm. After bonding the three sheets to each other, the sheets were subjected to cold pressing at room temperature for 20 minutes and the thermal pressure of 120° C. (10 kgf/cm²) was applied to the sheets for two minutes to obtain the target plywood. Each of the prepared plywood was processed into the size of 20×20×4.1 mm to serve as a test sample.

### Preparation Example 3

### Preparation of Preservative LVL with Phenol Resin

1000 g of the phenol resin-based glue Deernol D-117 (manufactured by Oshika Corporation), 70 g of wheat flour and 100 g of calcium carbonate were mixed and well kneaded. A solution of each of the compounds of Example 1 and Comparative Example 1, 2 and 5 to 25 was added to the kneaded product so that the final concentrations of the compound in the wood become 150, 100, 50 and 25 g/m³ and further kneaded. 18 g of the above kneaded product was applied onto each of the surface of glue line of the three Radiata pine veneer sheets having an area of 30 x 30 cm and thickness of 3 mm. After bonding the three sheets to each other, the sheets were subjected to cold pressing at room temperature for 20 minutes and the thermal pressure of 140° C. (10 kgf/cm²) was applied to the sheets for two minutes to obtain the target LVL. Each of the prepared LVL was processed into the size of 20×20×9 mm to serve as a test sample.

### Test Example 2

### Test for Antiseptic Effects of Preservative Plywood and LVL

The samples of the plywood and LVL prepared in Preparation Examples 2 and 3 were evaluated by the test for antiseptic effects for the drug pressure treatment according to JIS K1571:2004. The weather resistance operation and the test method for the antiseptic effect were performed according to the above test method. The results are shown in Tables 2 and 3. In the glue line method, while the compound of Comparative Example 1 showed the antiseptic effect on Fomitopsis palustris and Trametes versicolor in an amount of 50 g/m³ or more and the compound of Comparative Example 2 showed the antiseptic effect on Fomitopsis palustris in an amount of 50 g/m³ or more and on Trametes versicolor in an amount of 100 g/m³ or more, the other compounds of Comparative Examples had little antiseptic effect. On the other hand, epoxyconazole as being the compound of Example showed sufficient antiseptic effect in an amount of 25 to 50 g/m³.

TABLE 2
Test for antiseptic effects of preservative plywood

| | Fomitopsis palustris | | | | Trametes versicolor | | | |
|---|---|---|---|---|---|---|---|---|
| | Treated amount | | | | Treated amount | | | |
| | (absorbed amount | | | | (absorbed amount | | | |
| Antiseptic | per wood; g/m³) | | | | per wood; g/m³) | | | |
| composition | 25 | 50 | 100 | 150 | 25 | 50 | 100 | 150 |
| Example 1 | ◯ | ◯ | ◯ | ◯ | ◯ | ◯ | ◯ | ◯ |
| Comparative Ex. 1 | X | ◯ | ◯ | ◯ | X | ◯ | ◯ | ◯ |
| Comparative Ex. 2 | X | ◯ | ◯ | ◯ | X | X | ◯ | ◯ |
| Comparative Ex. 5 | X | X | X | ◯ | X | X | X | ◯ |
| Comparative Ex. 6 | X | X | X | X | X | X | X | X |
| Comparative Ex. 7 | X | X | X | X | X | X | X | X |
| Comparative Ex. 8 | X | X | X | X | X | X | X | X |
| Comparative Ex. 9 | X | X | X | X | X | X | X | X |
| Comparative Ex. 10 | X | X | X | X | X | X | X | X |
| Comparative Ex. 11 | X | X | X | X | X | X | X | X |
| Comparative Ex. 12 | X | X | X | X | X | X | X | X |
| Comparative Ex. 13 | X | X | X | X | X | X | X | X |
| Comparative Ex. 14 | X | X | X | X | X | X | X | X |
| Comparative Ex. 15 | X | X | X | X | X | X | X | X |
| Comparative Ex. 16 | X | X | X | X | X | X | X | X |
| Comparative Ex. 17 | X | X | X | X | X | X | X | X |
| Comparative Ex. 18 | X | X | X | X | X | X | X | X |
| Comparative Ex. 19 | X | X | X | X | X | X | X | X |
| Comparative Ex. 20 | X | X | X | X | X | X | X | X |
| Comparative Ex. 21 | X | X | X | X | X | X | X | X |
| Comparative Ex. 22 | X | X | X | X | X | X | X | X |
| Comparative Ex. 23 | X | X | X | X | X | X | X | X |
| Comparative Ex. 24 | X | X | X | X | X | X | X | X |
| Comparative Ex. 25 | X | X | X | X | X | X | X | X |

◯: The average rate of decrease in weight was less than 3%.
X: The average rate of decrease in weight was 3% or more.

TABLE 3
Test for antiseptic effects of preservative LVL

| | Fomitopsis palustris | | | | Trametes versicolor | | | |
|---|---|---|---|---|---|---|---|---|
| | Treated amount | | | | Treated amount | | | |
| | (absorbed amount | | | | (absorbed amount | | | |
| Antiseptic | per wood; g/m³) | | | | per wood; g/m³) | | | |
| composition | 25 | 50 | 100 | 150 | 25 | 50 | 100 | 150 |
| Example 1 | ◯ | ◯ | ◯ | ◯ | ◯ | ◯ | ◯ | ◯ |
| Comparative Ex. 1 | X | ◯ | ◯ | ◯ | X | ◯ | ◯ | ◯ |
| Comparative Ex. 2 | X | X | ◯ | ◯ | X | ◯ | ◯ | ◯ |
| Comparative Ex. 5 | X | X | X | ◯ | X | X | X | ◯ |
| Comparative Ex. 6 | X | X | X | X | X | X | X | X |
| Comparative Ex. 7 | X | X | X | X | X | X | X | X |
| Comparative Ex. 8 | X | X | X | X | X | X | X | X |
| Comparative Ex. 9 | X | X | X | X | X | X | X | X |
| Comparative Ex. 10 | X | X | X | X | X | X | X | X |
| Comparative Ex. 11 | X | X | X | X | X | X | X | X |
| Comparative Ex. 12 | X | X | X | X | X | X | X | X |
| Comparative Ex. 13 | X | X | X | X | X | X | X | X |
| Comparative Ex. 14 | X | X | X | X | X | X | X | X |
| Comparative Ex. 15 | X | X | X | X | X | X | X | X |
| Comparative Ex. 16 | X | X | X | X | X | X | X | X |
| Comparative Ex. 17 | X | X | X | X | X | X | X | X |
| Comparative Ex. 18 | X | X | X | X | X | X | X | X |
| Comparative Ex. 19 | X | X | X | X | X | X | X | X |
| Comparative Ex. 20 | X | X | X | X | X | X | X | X |
| Comparative Ex. 21 | X | X | X | X | X | X | X | X |
| Comparative Ex. 22 | X | X | X | X | X | X | X | X |
| Comparative Ex. 23 | X | X | X | X | X | X | X | X |
| Comparative Ex. 24 | X | X | X | X | X | X | X | X |
| Comparative Ex. 25 | X | X | X | X | X | X | X | X |

◯: The average rate of decrease in weight was less than 3%.
X: The average rate of decrease in weight was 3% or more.

### Preparation Example 4

### Preparation of Preservative Plywood with Urea Melamine Resin

The preservative plywood was prepared in the same manner in Preparation Example 2. Each of the prepared plywood was processed into the size of 8.9 x 8.9×100 mm to serve as a test sample.

### Preparation Example 5

### Preparation of Preservative LVL with Phenol Resin

The preservative LVL was prepared in the same manner in Preparation Example 3. Each of the prepared LVL was processed into the size of 9×9×100 mm to serve as a test sample.

### Test Example 3

### Test for Antiseptic Effects of Preservative Plywood and LVL (Fungus Cellar Soil-Bed Test)

The samples of the plywood and LVL prepared in Preparation Examples 4 and 5 were evaluated by the fungus cellar soil-bed test according to JIS K1571:2004. The weather resistance operation and the test method for the antiseptic effect were performed according to the above test method. The test was carried out for six months setting the test temperature to 25° C. (because the grade average of the decay damage of the non-treated test samples exceeded 2.5 in six months). The results are shown in Tables 4 and 5. Surprisingly, epoxyconazole as being the compound of Example showed sufficient antiseptic effect in an amount of 25 to 50 g/m³, while the compounds of Comparative Examples including those of Comparative Examples 1 and 2 which showed effect in Test Example 2 showed little effect in the glue line treatment. The effect in the glue line treatment was actually investigated with respect to a number of existing antiseptics, and it was confirmed that only epoxyconazole is suitable for the glue line treatment at a low concentration. That is, only epoxyconazole showed sufficient preservative activity under extreme conditions of the glue line treatment.

The Japanese Patent Publication No. 4223558 discloses a composition containing an insecticidal ingredient (imidacloprid) used in the glue line treatment and teaches that IPBC and azole such as tebuconazole, propiconazole and cyproconazole may be added as a fungicide together with the insecticidal ingredient. However, the active ingredient used in the wood preservative composition of the present invention showed outstanding effects compared to the compound described in the above patent. Accordingly, it is clear that the wood preservative composition of the present invention would not have been easily achieved by one of ordinary skill in the art based on the technology and the like described in the prior art document.

TABLE 4
Test for antiseptic effects of preservative plywood
(fungus cellar soil-bed test)

| | Grade average of the decay damage | | | |
|---|---|---|---|---|
| | of five test samples | | | |
| | Treated amount | | | |
| Antiseptic | (absorbed amount per wood; g/m³) | | | |
| composition | 25 | 50 | 100 | 150 |
| Non-treated test | 2.8 | | | |
| sample | | | | |
| Example 1 | 0.2 | 0 | 0 | 0 |
| Comparative Ex. 1 | 2.8 | 3.0 | 3.0 | 2.6 |
| Comparative Ex. 2 | 3.0 | 2.6 | 3.2 | 3.2 |
| Comparative Ex. 5 | 3.2 | 3.2 | 2.6 | 1.2 |
| Comparative Ex. 6 | 3.0 | 3.4 | 2.8 | 3.2 |
| Comparative Ex. 7 | 2.8 | 2.8 | 2.8 | 2.8 |
| Comparative Ex. 8 | 3.0 | 2.8 | 3.0 | 3.0 |
| Comparative Ex. 9 | 3.4 | 3.2 | 2.8 | 3.6 |
| Comparative Ex. 10 | 2.8 | 3.0 | 3.0 | 2.8 |
| Comparative Ex. 11 | 3.0 | 2.8 | 3.2 | 2.8 |
| Comparative Ex. 12 | 3.0 | 2.8 | 3.4 | 2.8 |
| Comparative Ex. 13 | 3.2 | 3.4 | 3.4 | 3.4 |
| Comparative Ex. 14 | 3.4 | 3.4 | 3.0 | 3.2 |
| Comparative Ex. 15 | 2.8 | 2.8 | 2.8 | 2.8 |
| Comparative Ex. 16 | 3.4 | 3.2 | 3.4 | 3.6 |
| Comparative Ex. 17 | 3.2 | 3.0 | 3.6 | 2.8 |
| Comparative Ex. 18 | 3.2 | 3.6 | 3.6 | 2.8 |
| Comparative Ex. 19 | 3.2 | 3.6 | 3.2 | 2.8 |
| Comparative Ex. 20 | 3.6 | 3.2 | 3.0 | 2.8 |
| Comparative Ex. 21 | 3.0 | 3.0 | 3.0 | 2.8 |
| Comparative Ex. 22 | 3.2 | 2.8 | 2.8 | 3.2 |
| Comparative Ex. 23 | 2.8 | 2.8 | 3.2 | 2.8 |
| Comparative Ex. 24 | 2.8 | 2.8 | 2.8 | 2.8 |
| Comparative Ex. 25 | 2.8 | 2.8 | 2.8 | 2.8 |

0: sound condition
1: partial and mild degree of decay
2: entire and mild degree of decay
3: partial and severe decay in addition to the status as described in 2
4: entire and severe decay
5: out of shape due to the decay

TABLE 5
Test for antiseptic effects of preservative LVL
(fungus cellar soil-bed test)

| | Grade average of the decay damage | | | |
|---|---|---|---|---|
| | of five test samples | | | |
| | Treated amount | | | |
| Antiseptic | (absorbed amount per wood; g/m³) | | | |
| composition | 25 | 50 | 100 | 150 |
| Non-treated test | 3.0 | | | |
| sample | | | | |
| Example 1 | 0.4 | 0 | 0 | 0 |
| Comparative Ex. 1 | 3.0 | 3.2 | 2.8 | 2.8 |
| Comparative Ex. 2 | 2.8 | 3.0 | 3.2 | 2.6 |
| Comparative Ex. 5 | 2.8 | 3.4 | 2.6 | 1.6 |
| Comparative Ex. 6 | 3.0 | 3.2 | 3.0 | 3.0 |
| Comparative Ex. 7 | 2.8 | 3.6 | 2.8 | 2.8 |
| Comparative Ex. 8 | 2.8 | 3.2 | 3.2 | 2.6 |
| Comparative Ex. 9 | 3.4 | 2.6 | 2.6 | 2.6 |
| Comparative Ex. 10 | 3.4 | 2.6 | 3.6 | 2.6 |
| Comparative Ex. 11 | 3.0 | 3.0 | 3.0 | 3.0 |
| Comparative Ex. 12 | 2.6 | 3.2 | 3.2 | 2.6 |
| Comparative Ex. 13 | 2.6 | 3.6 | 2.6 | 3.6 |
| Comparative Ex. 14 | 3.2 | 2.8 | 2.8 | 3.4 |
| Comparative Ex. 15 | 2.6 | 2.8 | 3.2 | 2.6 |
| Comparative Ex. 16 | 3.0 | 3.0 | 3.0 | 3.0 |
| Comparative Ex. 17 | 2.6 | 2.8 | 2.6 | 3.4 |
| Comparative Ex. 18 | 3.2 | 2.6 | 2.8 | 3.6 |
| Comparative Ex. 19 | 2.6 | 3.0 | 3.6 | 3.4 |
| Comparative Ex. 20 | 3.0 | 2.6 | 3.2 | 3.2 |
| Comparative Ex. 21 | 3.0 | 3.6 | 3.4 | 2.8 |
| Comparative Ex. 22 | 3.0 | 3.0 | 2.8 | 3.2 |
| Comparative Ex. 23 | 3.0 | 3.4 | 3.2 | 2.6 |
| Comparative Ex. 24 | 3.0 | 3.4 | 3.0 | 3.2 |
| Comparative Ex. 25 | 3.0 | 3.0 | 3.0 | 3.2 |

0: sound condition
1: partial and mild degree of decay
2: entire and mild degree of decay
3: partial and severe decay in addition to the status as described in 2
4: entire and severe decay
5: out of shape due to the decay

### INDUSTRIAL APPLICABILITY

The present invention provides a wood preservative composition prepared by mixing a specific antiseptic (epoxyconazole), which would not be degraded under manufacturing conditions, into glue used in the production of the engineering wood. The wood preservative composition of the present invention enables efficient production of engineering wood having a high antiseptic effect with the active ingredient blended in a small amount.

1. An antiseptic composition for producing engineering wood which contains epoxyconazole and thermosetting resin.

2. The antiseptic composition for producing engineering wood as claimed in claim 1, wherein the thermosetting resin is selected from a group consisting of phenol resin, phenol resorcinol copolymer resin, urea resin, urea melamine resin and melamine phenol resin.

3. The antiseptic composition for producing engineering wood as claimed in claim 1, wherein the engineering wood is plywood, laminated veneer lumber (LVL), a particle board or a fiber board.

4. Engineering wood produced by using the antiseptic composition as claimed in claim 1.

5. The engineering wood as claimed in claim 4, which is plywood, laminated veneer lumber (LVL), a particle board or a fiber board.
